(19) United States
(12) Patent Application Publication
(10) Pub. No.: US 2025/0254249 A1
(43) Pub. Date: Aug. 7, 2025

(54) IMAGE PROCESSING APPARATUS, CONTROL METHOD, AND STORAGE MEDIUM

(71) Applicant: CANON KABUSHIKI KAISHA, Tokyo (JP)

(72) Inventor: TOMOHIDE KUBOTA, Kanagawa (JP)

(21) Appl. No.: 19/036,709

(22) Filed: Jan. 24, 2025

(30) Foreign Application Priority Data
Feb. 2, 2024 (JP) 2024-014587

(51) Int. Cl. H04N 1/00; H04N 1/32

(52) U.S. Cl. CPC H04N 1/00408; H04N 1/0048; H04N 1/32144; H04N 2201/0094

(57) ABSTRACT

An image processing apparatus includes a generating unit configured to generate document data based on a read document, a setting unit configured to enable a correction mark setting for including a correction mark in the document data to be generated by the generating unit, the correction mark indicating that a correction has been made in the document, and a display control unit configured to perform, in a case where the correction mark setting is enabled, display control regarding the enabling of the correction mark setting.

### BACKGROUND

### Field of the Disclosure

The present invention relates to an image processing apparatus, a control method, and a storage medium.

### Description of the Related Art

Single-function reading apparatuses (such as scanner apparatuses) and image reading apparatuses (such as scanners) installed in copy machines are available as apparatuses that optically scan documents, such as paper documents, and generate document data, such as electronic documents. In recent years, mobile terminals are also available for use as document scanners (hereinafter, the foregoing apparatuses will be collectively referred to as “reading apparatus”).

Meanwhile, tax-related forms and other documents have been recognized as “originals” only in paper form. However, electronic documents have also been accepted as originals in recent years, provided that predetermined conditions are satisfied, due to changes in the legal system accompanying advancements in electronic document technology. One of the conditions for accepting an electronic document as an “original” is that when a document containing a mark indicating that the document has been corrected (e.g., a mark such as a correction fluid mark) (hereinafter, “correction mark”) is digitized, information about the correction mark is not lost (i.e., visibility of the correction mark is preserved). Thus, in order to leave correction marks, a method in which a setting for including correction marks is automatically used in executing a job is discussed.

However, change of a setting value for leaving correction marks is automatically executed after a user performs an operation to execute a scan process, and thereafter a scan is executed. This can sometimes make it difficult for the user to identify the setting value used in executing the scan.

### SUMMARY

The present disclosure is directed to improving usability in a case where a scan is executed in such a manner that correction marks are left.

According to an aspect of the present disclosure, an image processing apparatus includes a generating unit configured to generate document data based on a read document, a setting unit configured to enable a correction mark setting for including a correction mark in the document data to be generated by the generating unit, the correction mark indicating that a correction has been made in the document, and a display control unit configured to perform, in a case where the correction mark setting is enabled, display control regarding the enabling of the correction mark setting.

Further features of the present disclosure will become apparent from the following description of embodiments with reference to the attached drawings.

### BRIEF DESCRIPTION OF THE DRAWINGS

FIG. 1 is a diagram illustrating an overview of an image processing system according to a first embodiment.

FIG. 2 is a block diagram illustrating a configuration of a multi-function peripheral (MFP) 101 according to the first embodiment.

FIG. 3 is a diagram illustrating an application configuration according to the first embodiment.

FIGS. 4A to 4F are diagrams illustrating example of screens displayed on an operation display unit according to the first embodiment.

FIG. 5 is a flowchart illustrating an example of a process when the user presses an “include marks such as correction fluid marks” button according to the first embodiment.

FIGS. 6A to 6C are diagrams illustrating examples of screens displayed on the operation display unit in a case where an “include marks such as correction fluid marks” setting is enabled according to the first embodiment.

FIG. 7 is a flowchart illustrating an example of a setting screen display process according to the first embodiment.

FIG. 8 is a flowchart illustrating an example of a transmission destination selection and confirmation process according to the first embodiment.

FIG. 9 is a diagram illustrating an example of an address book screen according to the first embodiment.

FIG. 10 is a flowchart illustrating an example of a process at the start of a scan according to the first embodiment.

FIGS. 11A to 11C are diagrams illustrating examples of an address book screen and a pop-up screen to be displayed at the start of a scan according to the first embodiment.

FIGS. 12A to 12D are diagrams illustrating examples of setting screens according to a second embodiment.

FIG. 13 is a flowchart illustrating an example of a setting screen display process according to the second embodiment.

FIG. 14 is a diagram illustrating an example of a setting screen to a third embodiment.

FIG. 15 is a flowchart illustrating an example of a setting screen display process according to the third embodiment.

FIG. 16 is a flowchart illustrating an example of a setting screen display process according to a fourth embodiment.

### DESCRIPTION OF THE EMBODIMENTS

The present disclosure will be described in detail below with reference to the accompanying drawings. Embodiments described below are not intended to limit the claimed disclosure. Further, not all combinations of features described in the embodiments are necessarily essential to the technical solution of the present disclosure. In the attached drawings, corresponding or similar components are assigned the same reference numeral, and redundant descriptions thereof are omitted.

### System Configuration

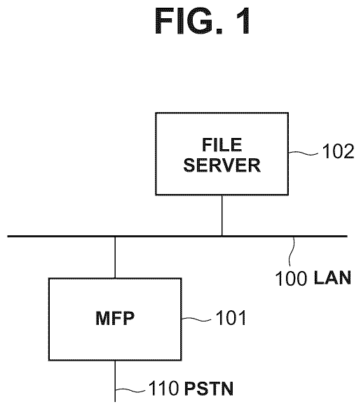

FIG. 1 is a diagram illustrating an example of an image processing system according to the present embodiment. On a local area network (LAN) 100, a multi-function peripheral (MFP) 101 and a file server 102 are connected to communicate with each other. The MFP 101 is an example of an image processing apparatus. The file server 102 is an example of a file management apparatus (information processing apparatus). However, the description above is not limiting, and the MFP 101 may be any image processing apparatus equipped with a reading apparatus. A printer having a printing function to print image data onto a document may also be employed. The printer may employ an electrophotographic, inkjet, or other printing methods.

The MFP 101 is capable of transmitting an image data file to a folder in the file server 102 as a destination using a file transfer protocol. Examples of file transfer protocols include Server Message Block (SMB) and File Transfer Protocol (FTP). The file transmission destination of the MFP 101 is not limited to the file server 102, and folders in a host personal computer (host PC) (not illustrated) can also be specified as the destination. The MFP 101 can transmit image data via email through mail servers (not illustrated). The MFP 101 is connected to a public switched telephone network (PSTN) 110 and can transmit and receive faxes to and from fax apparatuses (not illustrated). The MFP 101 is connected to the Internet (not illustrated) and may be configured to transmit data to other apparatuses through the Internet.

In a case where a destination list stored in a device (e.g., the file server 102) in the image processing system is made public, the MFP 101 can acquire the destination list through the LAN 100 and use the acquired destination list.

While the image processing system includes both the MFP 101 and the file server 102, only the MFP 101 may be referred to as the image processing system. The system that includes the host PC (not illustrated) or a management server may be referred to as the image processing system.

### Hardware Configuration

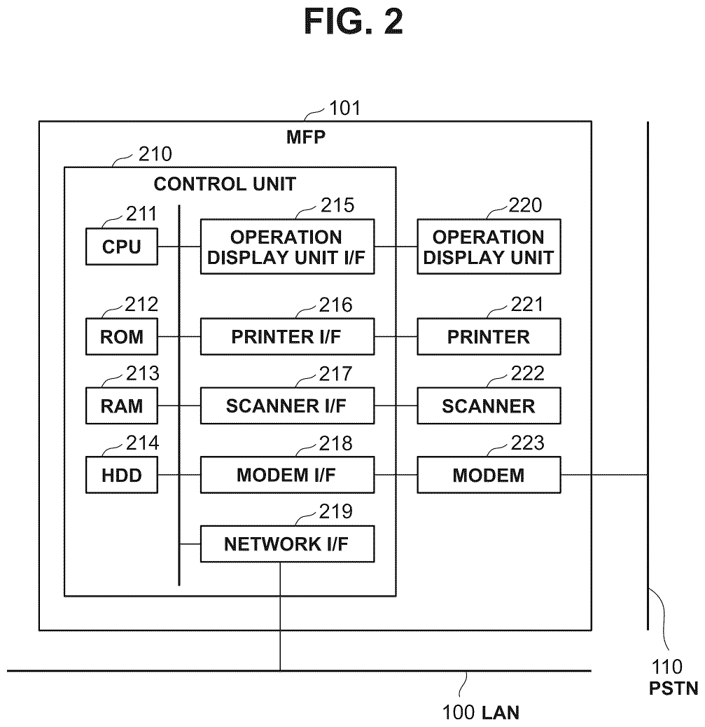

FIG. 2 is a block diagram illustrating a hardware configuration of the MFP 101. The MFP 101 includes a control unit 210, an operation display unit 220, a printer 221, a scanner 222, and a modem 223. The control unit 210 includes a central processing unit (CPU) 211, a read-only memory (ROM) 212, a RAM 213, a hard disk drive (HDD) 214, an operation display unit interface (operation display unit I/F) 215, a printer interface (printer I/F) 216, a scanner interface (scanner I/F) 217, a modem interface (modem I/F) 218, and a network interface (network I/F) 219.

The control unit 210 including the CPU 211 controls the entire operation of the MFP 101. The CPU 211 reads control programs stored in the ROM 212 and performs various types of control, such as reading control and transmission control. The RAM 213 is used as a main memory of the CPU 211 and also as a temporary storage area, such as a work area. While the MFP 101 is configured so that one CPU 211 executes processes illustrated in flowcharts described below using one memory (the RAM 213 or the HDD 214), other configurations may also be employed. For example, a plurality of CPUs and a plurality of RAMs or HDDs may be configured to collaborate to execute the processes illustrated in the flowcharts described below.

The HDD 214 stores image data and various programs. The operation display unit I/F 215 connects the operation display unit 220 and the control unit 210 to each other. The operation display unit 220 includes a liquid crystal display unit with a touch panel function and a keyboard. The liquid crystal display unit can display information about the MFP 101 and receive user operations.

The printer I/F 216 connects the printer 221 and the control unit 210 to each other. Image data for use in printing by the printer 221 is transferred from the control unit 210 via the printer I/F 216 and printed onto a recording medium by the printer 221.

The scanner I/F 217 connects the scanner 222 and the control unit 210 to each other. The scanner 222 reads an image on a document to generate image data (image file) and inputs the generated image data to the control unit 210 via the scanner I/F 217. The MFP 101 can transmit the image data (image file) generated by the scanner 222 via file transfer or email.

The modem I/F 218 connects the modem 223 and the control unit 210 to each other. The modem 223 connects the control unit 210 (the MFP 101) to the PSTN 110. The modem 223 performs fax transmission and reception with fax apparatuses over the PSTN 110.

The network I/F 219 connects the control unit 210 (the MFP 101) to the LAN 100. The network I/F 219 transmits image data and information to external apparatuses (such as the file server 102) on the LAN 100 and receives various types of information from the external apparatuses.

### Software Configuration

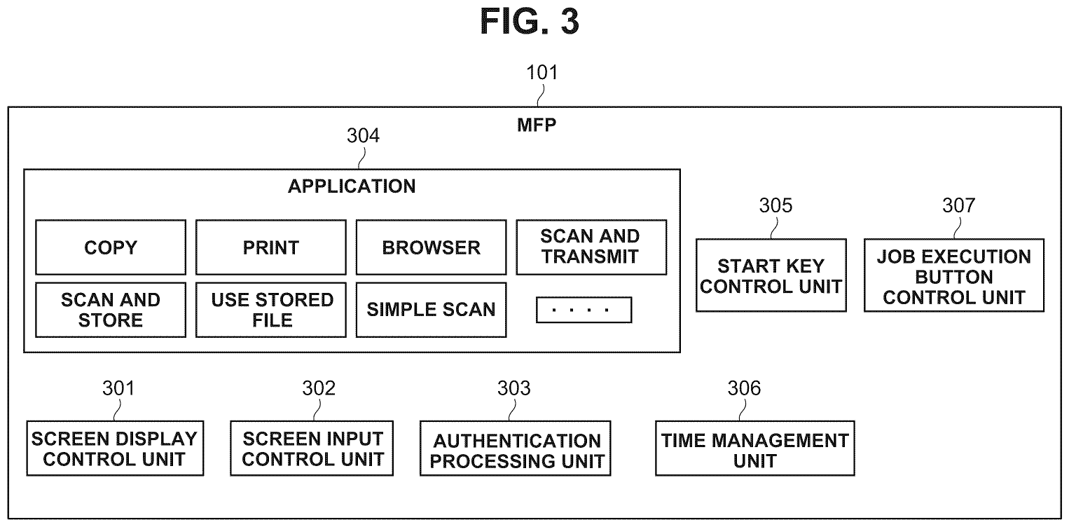

FIG. 3 is a block diagram illustrating an example of a software configuration of the MFP 101. According to the present embodiment, unless otherwise specified, the interaction between illustrated software modules is implemented by the CPU 211 executing processes based on programs stored in the ROM 212 or the HDD 214. The CPU 211 controls the ROM 212, the RAM 213, the HDD 214, the operation display unit I/F 215, the printer I/F 216, the scanner I/F 217, the modem I/F 218, and the network I/F 219.

The control unit 210 includes a screen display control unit 301, a screen input control unit 302, an authentication processing unit 303, an application 304, a start key control unit 305, a time management unit 306, and a job execution button control unit 307.

The screen display control unit 301 mainly performs a process of managing the screens of the entire application 304, a process of transferring screen information to the operation display unit 220, and a process of notifying the application 304 of events input from the operation display unit 220.

The operation display unit I/F 215 converts operations from the operation display unit 220 into a signal, and the screen input control unit 302 receives the signal, analyzes the signal, and converts the signal into an input signal in the form of an event that can be transmitted to the application 304. The screen input control unit 302 notifies the input signal to the screen display control unit 301.

The authentication processing unit 303 displays an authentication screen on the operation display unit 220 and performs user authentication using authentication information, such as an identifier (ID) and a password, input from a user. In a case where the user authentication is successful, the authentication processing unit 303 performs a login process to log the user into the MFP 101. In a case where a logout instruction is issued, the authentication processing unit 303 performs a logout process to log the logged-in user out of the MFP 101.

The application 304 is a set of applications running on the MFP 101, and the CPU 211 runs each application based on instructions from the user via the screen input control unit 302. Among the applications of the MFP 101, the primary applications are as follows:
An application program with a “copy” function that causes the printer 221 to print image data generated by scanning an image on a document with the scanner 222.
An application program with a “print” function that causes the printer 221 to print image data based on a print job input from an external apparatus, such as a personal computer (PC).
An application program with a “scan-and-transmit” function that externally transmits image data generated by scanning an image on a document with the scanner 222.
An application program with a “scan-and-store” function that stores image data generated by scanning an image on a document with the scanner 222 in an external memory.
An application program with a “use stored file” function that prints image data stored in the external memory, using the printer 221 or transmits the stored image data externally.
An application program with a “browser” function that displays, prints, and saves data on a web server through a web browser.
An application program with a “simple scan” function that limits the “scan-and-transmit” function to only some key settings to enable easy use of the “scan-and-transmit” function.

The application 304 of the MFP 101 is not limited to the examples described above. The application 304 may be added later based on a user instruction.

The start key control unit 305 detects the press of a start key through the screen input control unit 302 and transmits a start key execution notification to the application 304. The application 304 having received the start key execution notification executes the corresponding function.

The time management unit 306 manages the current time from the activation of the MFP 101 and issues a notification of the current time based on an instruction from the start key control unit 305 or the job execution button control unit 307.

The job execution button control unit 307 configures settings for the function of the corresponding application based on instructions from the user, and stores the settings in the HDD 214. The job execution button control unit 307 detects the press of a registered job execution button, calls the corresponding application 304, and executes the application 304 based on the settings registered in advance and stored in the HDD 214.

The configuration illustrated in FIG. 3 is merely an example and is not limiting. The configuration illustrated in FIG. 3 may be partially omitted or may include additional components.

In Japan, the Electronic Books Maintenance Act (Dencho Law) has been amended to allow scanned data that meets certain conditions to be treated as official documents. One of these conditions is that when content has been modified, the modification must be verifiable and that correction marks are recognizable (Article 4, Section 27). Thus, to leave correction marks, a method is known for executing a job with a setting value with which correction marks are left.

However, in a case where the job is executed after an automatic change to the setting value with which correction marks are left following the operation by the user to execute the scan process, the user may not be able to identify the setting value used for the job. For example, in a case where, in order to leave a correction mark, a setting value is automatically changed to a setting value that is different from the one set by user and a job is executed, an outcome obtained by executing a scan is not the same as an outcome of a scan executed with the setting value set by the user. In this case, the user obtains an outcome (scanned data) of a scan executed with the setting value different from the setting value set by the user, which may result in decreased usability. Furthermore, in a case where the setting for leaving correction marks is enabled, if a setting value of a setting related to the setting for leaving correction marks is changed by the user, there is a possibility that an outcome (scanned data) without correction marks may be obtained.

Thus, in the present embodiment, the image processing apparatus issues a notification of setting values used to execute a scan in a case where the setting for leaving correction marks is enabled. Specifically, in a case where the setting for leaving correction marks is enabled, the image processing apparatus displays setting values of setting items set so as to leave correction marks (the setting items related to the setting for leaving correction marks).

This enables the user to perform an operation to execute a job with a grasp of setting values to be used to execute a scan. Therefore, the likelihood of obtaining scanned data generated by a scan executed with setting values different from the values that the user has grasped decreases, thus improving usability.

In the present embodiment, in a case where the setting for leaving correction marks is enabled, the image processing apparatus performs control so that setting values whose changes disable the setting for leaving correction marks, among the setting values for the setting related to the setting for leaving correction marks, are prevented from being changed. In other words, the setting values whose changes affect the setting for leaving correction marks are made unselectable. Specifically, in a case where the setting for leaving correction marks is enabled, the image processing apparatus grays out and displays the setting values whose changes disable the setting for leaving correction marks, or hides the setting values whose changes disable the setting for leaving correction marks.

This reduces the likelihood of the user unintentionally changing the setting value for leaving marks such as correction fluid marks, thus improving usability.

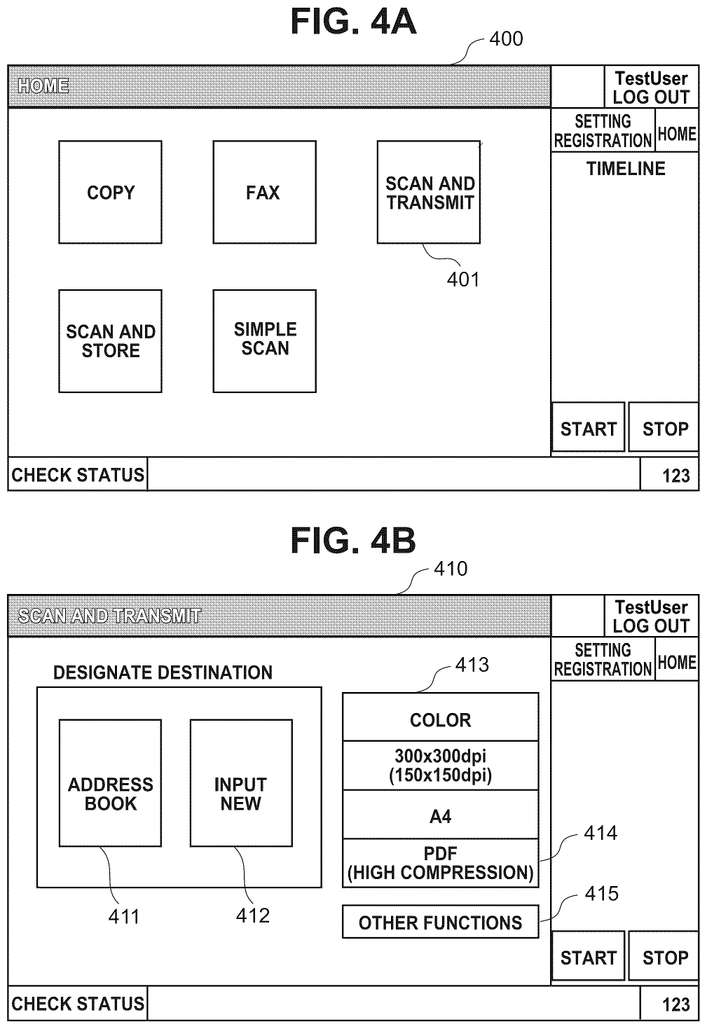

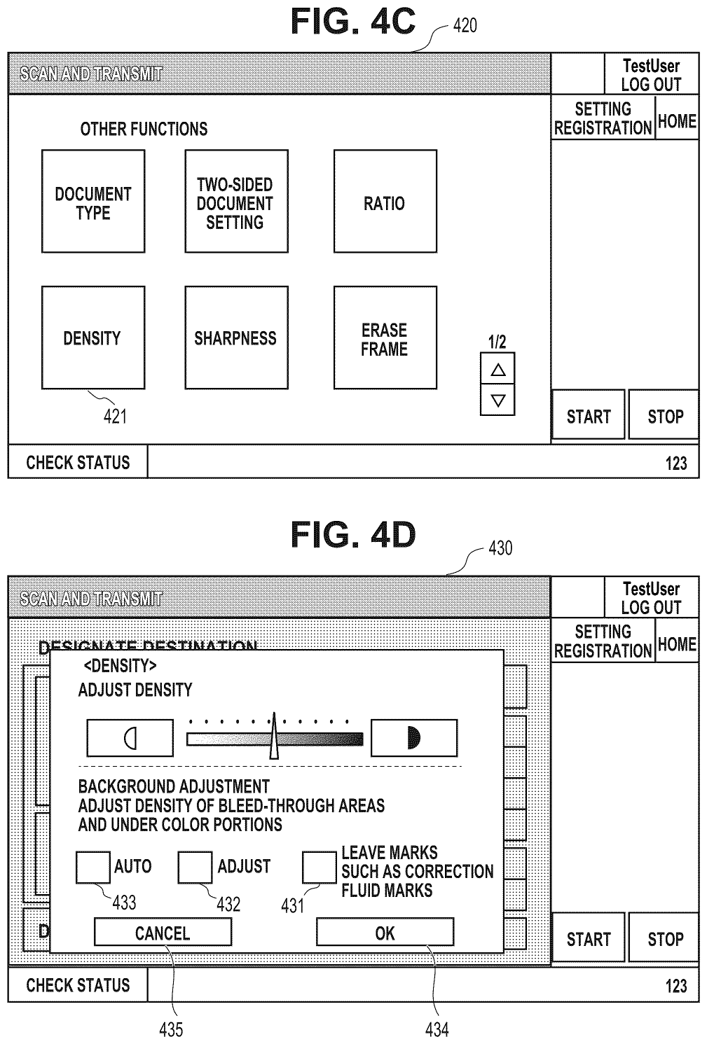

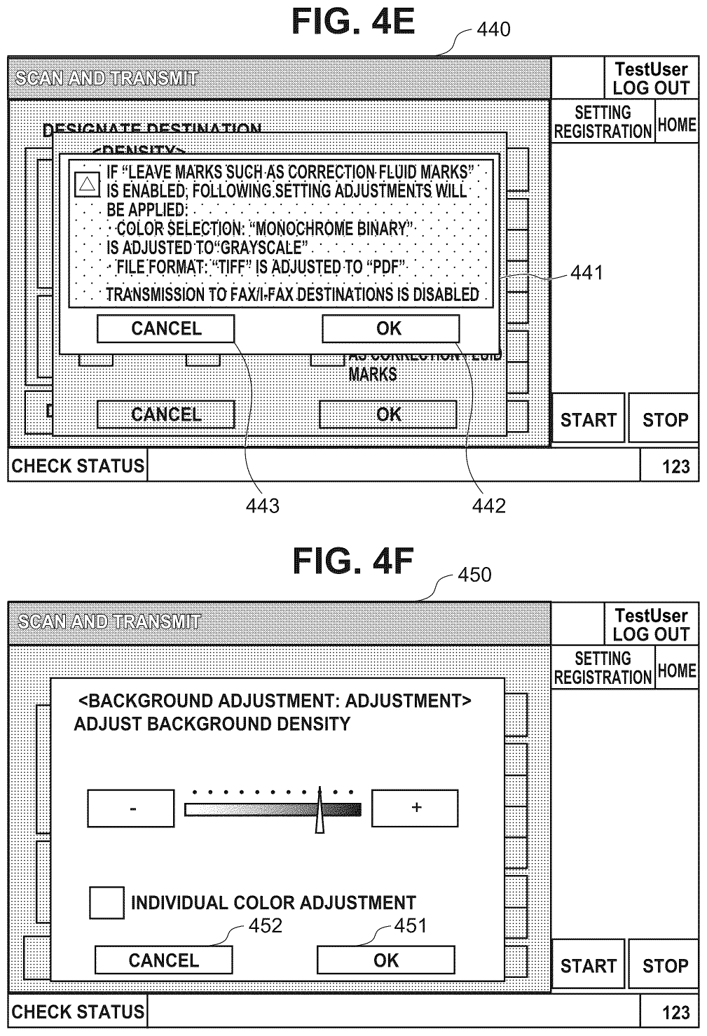

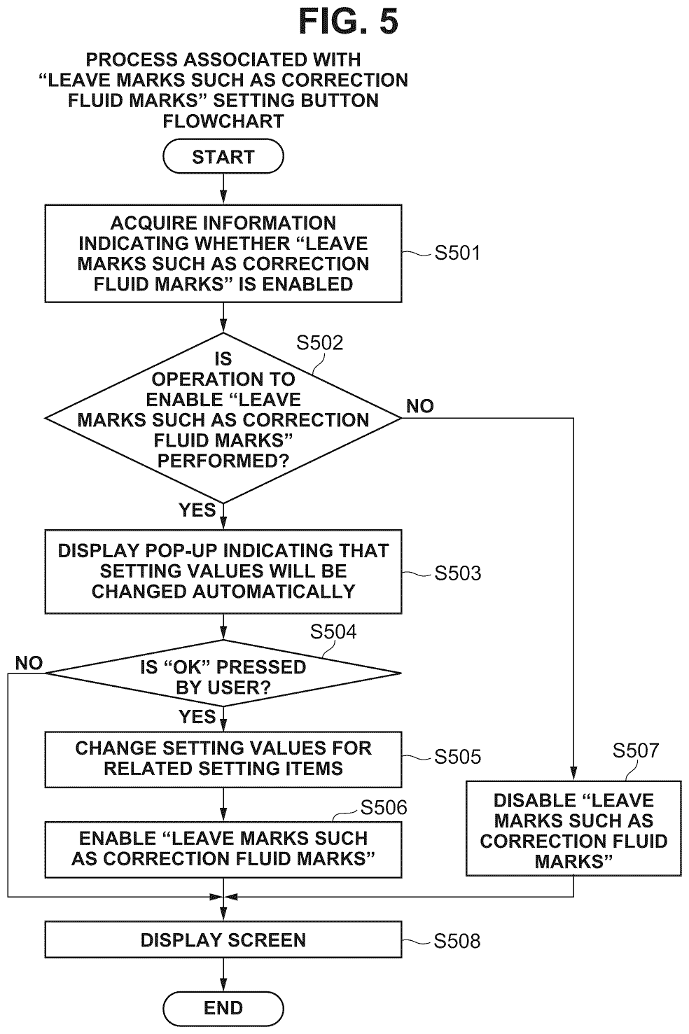

An example of a process of changing a group of setting items related to the setting for leaving correction marks (density, color selection, file format, and background color process are treated as the group of related setting items in the present embodiment) to specific values will be described below with reference to FIGS. 4A to 4F and 5.

### Operation Screen

FIGS. 4A to 4F are diagrams illustrating examples of screens displayed on the operation display unit 220 in the present embodiment. The screens illustrated in FIGS. 4A to 4F are displayed by the screen display control unit 301. FIG. 4A illustrates an example of a home (menu) screen 400. On the home screen 400, icons for using the application 304 are arranged. The home screen 400 in FIG. 4A is an initial screen to be displayed when the MFP 101 is activated, or a screen to be displayed when a user presses a home button on another screen. The present embodiment describes a form that uses a scan-and-transmit application as an example of the application 304 using the scanner 222.

FIG. 4B illustrates an example of a main screen (hereinafter, referred to as “scan-and-transmit screen 410”) of the scan-and-transmit application. The scan-and-transmit screen 410 in FIG. 4B is displayed on the operation display unit 220 when the user presses a scan-and-transmit button 401 on the home screen 400 in FIG. 4A. The scan-and-transmit screen 410 includes destination buttons (an address book button 411, an input-new button 412), buttons for setting major setting items (such as a color selection button 413, a file format selection button 414, and a sheet selection button), and an other-functions button 415. Descriptions of buttons that are not focused on in the present embodiment are omitted.

FIG. 4C illustrates an example of an other-functions screen 420. The other-functions screen 420 in FIG. 4C is displayed on the operation display unit 220 in response to the user pressing the other-functions button 415 on the scan-and-transmit screen 410 in FIG. 4B. The other-functions screen 420 includes buttons (such as a density button 421) for opening setting screens. Descriptions of buttons that are not focused on in the present embodiment are omitted.

FIG. 4D illustrates an example of a density setting screen 430. The density setting screen 430 in FIG. 4D is displayed on the operation display unit 220 in response to the user pressing the density button 421 on the other-functions screen 420 in FIG. 4C. On the density setting screen 430, the user can configure density and background density settings. The background density herein refers to a density setting restricted to a background area excluding text and image areas. The density setting screen 430 includes an icon indicating the current density setting, an icon for changing the density setting, an “leave marks such as correction fluid marks” (correction mark setting) button 431, a background density adjust button 432, a background density auto button 433, an OK button 434 for applying the changes to the settings on the screen and closing the screen, and a cancel button 435 for closing the screen without applying the settings. Descriptions of buttons that are not focused on in the present embodiment are omitted. In the present embodiment, the “leave marks such as correction fluid marks” button 431 is a button for collectively changing one or more setting items related to the “leave marks such as correction fluid marks” setting. For example, in the present embodiment, pressing the “leave marks such as correction fluid marks” button 431 changes the setting values for the related settings such as background density, color selection, file format, and under color removal (step S505 described below). The background density, color selection, and file format are setting items for which the setting values are changeable on a background adjustment screen (450 described below), a color selection screen (600 described below), and a file format screen (610 described below), respectively. On the other hand, the under color removal is a setting item that does not have a screen for the user to change its setting value. In the present embodiment, the “leave marks such as correction fluid marks” button 431 is arranged near the background density (in the density setting screen 430), which is the most strongly related setting item among the related setting, while the setting screens for the other setting items do not include the “leave marks such as correction fluid marks” button 431. In the present embodiment, the “leave marks such as correction fluid marks” button 431 is either in an enabled state or in a disabled state, and when the “leave marks such as correction fluid marks” button 431 is enabled, the “leave marks such as correction fluid marks” button 431 is highlighted (e.g., illuminates in yellow).

FIG. 4E illustrates an example of a pop-up 440 for confirming the details of the setting changes. The pop-up 440 for confirming the details of the setting changes in FIG. 4E is displayed on the operation display unit 220 in response to the user pressing the “leave marks such as correction fluid marks” button 431 on the density setting screen 430 in FIG. 4D to be enabled. The pop-up 440 for confirming the details of the setting changes includes a message field 441, an OK button 442 for allowing a setting change process, and a cancel button 443 for rejecting the setting change process. Descriptions of buttons that are not focused on in the present embodiment are omitted.

FIG. 4F illustrates an example of a background adjustment screen 450. The background adjustment screen 450 in FIG. 4F is displayed on the operation display unit 220 in response to the user pressing the background density adjust button 432 on the density setting screen 430 in FIG. 4D. The background adjustment screen 450 includes a set of icons for background density adjustment, an OK button 451 for applying changes and closing the screen, and a cancel button 452 for rejecting changes and closing the screen. Descriptions of buttons that are not focused on in the present embodiment are omitted. In a case where the background density auto button 433 on the density setting screen 430 is pressed by the user, the background adjustment screen 450 is not displayed, and the background density is adjusted automatically during job execution.

FIG. 5 is a diagram illustrating an example of a flowchart for a process to be executed in response to the “leave marks such as correction fluid marks” button 431 being pressed. The CPU 211 of the MFP 101 reads programs for implementing the control modules from the ROM 212 into the RAM 213 and executes the read programs, thereby realizing the flowchart in FIG. 5. Some or all of the functions of the steps illustrated in FIG. 5 may be implemented by hardware, such as an application-specific integrated circuit (ASIC) or electronic circuit. The symbol “S” in the description of each process denotes a step in the flowchart (the same applies to the following flowcharts in the present specification).

The flowchart in FIG. 5 is initiated based on the user pressing the “leave marks such as correction fluid marks” button 431 on the density setting screen 430 in FIG. 4E.

In step S501, the screen display control unit 301 acquires information indicating the current state of the “leave marks such as correction fluid marks” button 431, and the processing proceeds to step S502. Specifically, information indicating whether the “leave marks such as correction fluid marks” button 431 is in the enabled state or in the disabled state is acquired.

In step S502, the screen display control unit 301 determines whether the “leave marks such as correction fluid marks” button 431 acquired in step S501 is enabled. Specifically, the screen display control unit 301 determines whether the user operation on the “leave marks such as correction fluid marks” button 431 on the density setting screen 430 in FIG. 4E is an operation to enable the “leave marks such as correction fluid marks” setting. Here, the state of the “leave marks such as correction fluid marks” button 431 is either the enabled (ON) state or the disabled (OFF) state, pressing the “leave marks such as correction fluid marks” button 431 changes to the other state. Specifically, in a case where the information acquired in step S501 indicates that the “leave marks such as correction fluid marks” button 431 is disabled and the “leave marks such as correction fluid marks” button 431 is pressed, the user operation on the “leave marks such as correction fluid marks” button 431 is determined to be an operation to enable the “leave marks such as correction fluid marks” setting. On the other hand, in a case where the information acquired in step S501 indicates that the “leave marks such as correction fluid marks” button 431 is enabled and the “leave marks such as correction fluid marks” button 431 is pressed, the user operation on the “leave marks such as correction fluid marks” button 431 is determined to be an operation to disable the “leave marks such as correction fluid marks” setting. In a case where a determination result in step S502 by the screen display control unit 301 indicates “YES” (YES in step S502), the processing proceeds to step S503, whereas in a case where the determination result indicates “NO” (NO in step S502), the processing proceeds to step S507.

In step S503, the screen display control unit 301 displays the pop-up 440 for confirming the details of the setting changes in FIG. 4E on the operation display unit 220, and the processing proceeds to step S504.

In step S504, the screen display control unit 301 determines whether the OK button 442 is pressed by the user. Specifically, the screen display control unit 301 awaits a user operation (the press of the OK button 442 or the cancel button 443) and determines whether the performed user operation is the press of the OK button 442 or the cancel button 443. In a case where the screen display control unit 301 determines that the button pressed by the user is the OK button 442 in step S504 (YES in step S504), the pop-up 440 for confirming the details of the setting changes is closed, and the processing proceeds to step S505. On the other hand, in a case where the screen display control unit 301 determines that the button pressed by the user is not the OK button 442 in step S504, i.e., the screen display control unit 301 determines that the button pressed by the user is the cancel button 443 (NO in step S504), the pop-up 440 for confirming the details of the setting changes is closed, and the processing proceeds to step S508. The timing for closing the pop-up 440 for confirming the details of the setting changes is not restricted, and the closing may be executed in a case where the processing proceeds to step S508.

In step S505, the screen display control unit 301 (adjusts) changes the setting values for the setting items related to the “leave marks such as correction fluid marks” setting, and the processing proceeds to step S506. In the present embodiment, the following correction processes are performed:
Background density is adjusted to “maximum”.
In a case where “monochrome binary” is selected in color selection, “monochrome binary” is adjusted to “grayscale”.
In a case where “TIFF” (Tagged Image File Format [TIFF]) is selected as file format, “TIFF” is adjusted to “PDF” (Portable Document Format (PDF)).
Background color process is adjusted to “OFF” (no corresponding setting screen).

In the present embodiment, the background density, color selection, file format, and background color process are adjusted. However, this is not a limitation. For example, only some of the related setting items may be determined as adjustment targets, or setting items other than the related setting items may be included as adjustment targets. Specifically, only the background density may be determined as an adjustment target, a sharpness (edge enhancement process) setting may be set to a default value, in addition to the related setting items, and/or a preview display setting after reading may be enabled (ON).

In step S506, the screen display control unit 301 enables (ON) the “leave marks such as correction fluid marks” setting, and the processing proceeds to step S508.

In step S507, the screen display control unit 301 disables (OFF) the “leave marks such as correction fluid marks” setting, and the processing proceeds to step S508. In the present embodiment, the process of adjusting the setting values for the related setting items is not performed in a case where the “leave marks such as correction fluid marks” setting is disabled. However, this is not a limitation. For example, the setting values prior to changing may be stored in the RAM 213 when the “leave marks such as correction fluid marks” setting is enabled, and the setting values may be restored when the “leave marks such as correction fluid marks” setting is disabled.

In step S508, in a case where the “leave marks such as correction fluid marks” setting is enabled (ON), the screen display control unit 301 displays a density setting screen (620 described below), and the process in the flowchart is terminated. In a case where the “leave marks such as correction fluid marks” setting is disabled (OFF), the screen display control unit 301 displays the density setting screen 430, and the process in the flowchart is terminated. While an example of displaying the density setting screen 430 is described above, this is not a limitation. For example, a screen to be displayed at activation (the home screen 400 in the present embodiment) may be displayed, or an initial screen of the application (the scan-and-transmit screen 410 in the present embodiment) may be displayed. Further, the screen display may be executed after a screen for notifying the user of information is displayed or a user operation is performed.

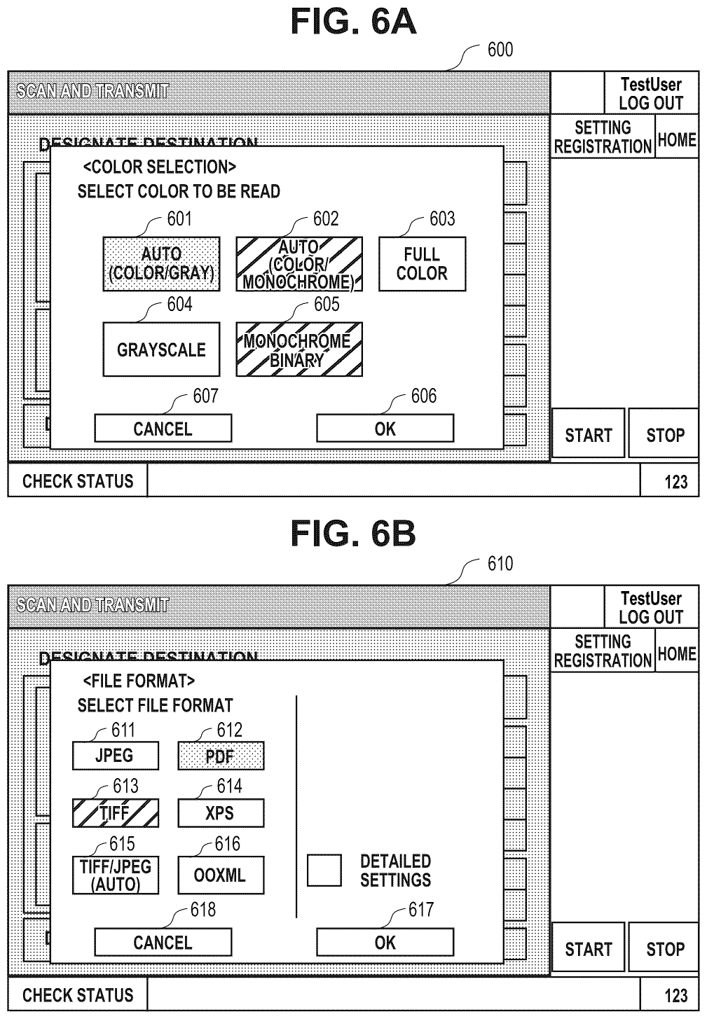

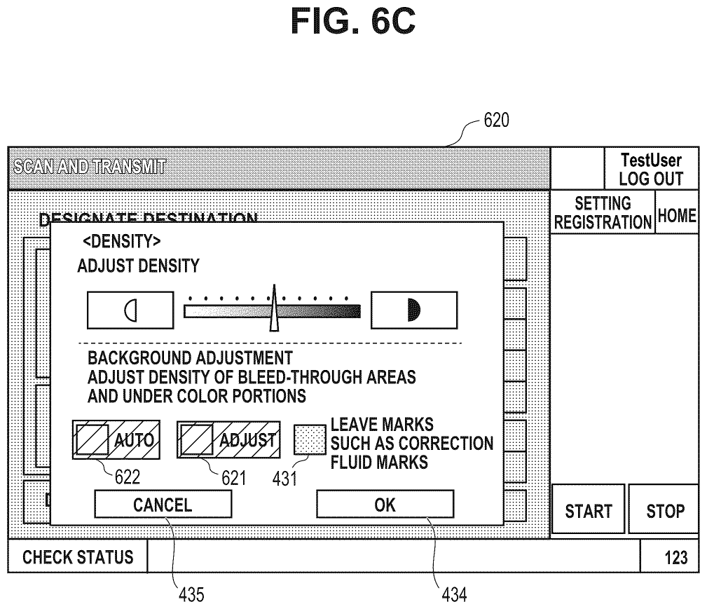

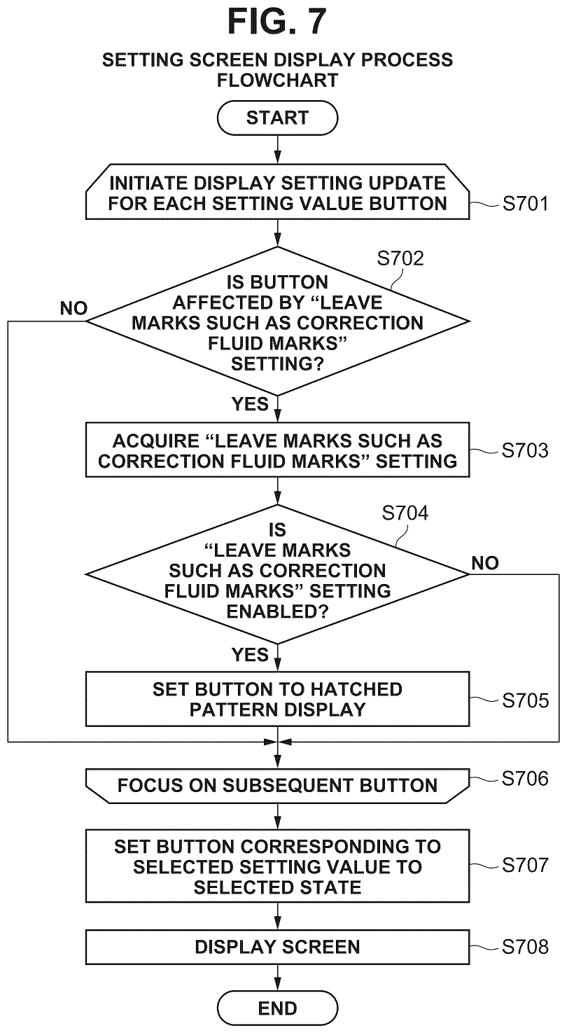

A process of displaying each setting screen in the scan-and-transmit application will be described below with reference to FIGS. 6A to 6C and 7. The setting screens for the setting items that are affected by the “leave marks such as correction fluid marks” setting are focused setting screens. The setting items that are affected here refer to the setting items related to the “leave marks such as correction fluid marks” setting. For example, in the present embodiment, the setting items that are affected refer to color selection (which affects the color selection screen 600), file format (which affects the file format screen 610), and background density (which affects the density screen 620).

FIGS. 6A to 6C are diagrams illustrating examples of setting screens for setting items that are candidates for the setting value adjustment in step S505 in the case where the “leave marks such as correction fluid marks” setting is enabled (ON). The screens illustrated in FIGS. 6A to 6C are displayed on the operation display unit 220 by the screen display control unit 301.

FIG. 6A illustrates an example of the color selection screen 600. The color selection screen 600 in FIG. 6A is displayed on the operation display unit 220 in response to the color selection button 413 on the scan-and-transmit screen 410 in FIG. 4B being pressed. The color selection screen 600 includes color setting value buttons 601 to 605, an OK button 606, and a cancel button 607. Each color setting value button is associated with a different setting value. In particular, for the auto (color/gray) button 601 and the auto (color/monochrome) button 602, the scanner 222 detects whether the document is a color document while reading the document. In a case where the document is a color document, the color setting is applied. Otherwise, the other setting value is applied.

Here, based on the “leave marks such as correction fluid marks” setting being enabled (ON), selected color setting value buttons are highlighted while unavailable color setting value buttons are displayed with a hatched pattern (grayed out) on the color selection screen 600. For example, in the case of FIG. 6A, the auto (color/gray) button 601 is selected, and display control is performed to display the auto (color/monochrome) button 602 and the monochrome binary button 605 as unavailable.

FIG. 6B illustrates an example of the file format screen 610. The file format screen 610 in FIG. 6B is displayed on the operation display unit 220 in response to the file format selection button 414 on the scan-and-transmit screen 410 in FIG. 4B being pressed. The file format screen 610 includes file format setting value buttons 611 to 616, an OK button 617, and a cancel button 618. Each file format setting value button is in association with a different setting value. In particular, for the TIFF/Joint Photographic Experts Group (JPEG) (auto) button 615, the scanner 222 detects whether the document is a monochrome binary document while reading the document. In a case where the document is a monochrome binary document, the setting value “TIFF” is applied. Otherwise, the setting value “JPEG” is applied. Although the TIFF/JPEG (auto) button 615 is selectable, documents are read in JPEG format, even if the TIFF/JPEG (auto) button 615 is selected. A notification indicating that documents are not read in TIFF format (documents are read in JPEG format) may be provided in a case where the TIFF/JPEG (auto) button 615 is pressed.

Here, based on the “leave marks such as correction fluid marks” setting being enabled (ON), selected file format setting value buttons are highlighted while unavailable file format setting value buttons are displayed with a hatched pattern on the file format screen 610. For example, in the case of FIG. 6B, the PDF button 612 is being selected, and display control is performed to display the TIFF button 613 as unavailable.

FIG. 6C illustrates an example of a density setting screen that is displayed again in a case where the “leave marks such as correction fluid marks” button 431 on the density setting screen 430 is pressed and the “leave marks such as correction fluid marks” setting is enabled (ON). On the screen, the “leave marks such as correction fluid marks” button 431 is highlighted. In a case where the background density is unchangeable, a background density adjust button 621 and a background density auto setting button 622 are displayed with a hatched pattern (e.g., displayed as illustrated in FIG. 6C), so that the background density adjust button 621 and the background density auto setting button 622 are unavailable.

FIG. 7 is a diagram illustrating an example of a flowchart for a process of displaying the setting screens illustrated in FIGS. 6A to 6C. The CPU 211 of the MFP 101 reads programs for implementing the control modules from the ROM 212 into the RAM 213 and executes the read programs, thereby realizing the flowchart in FIG. 7. Some or all of the functions of the steps illustrated in FIG. 7 may be implemented by hardware, such as an ASIC or electronic circuit.

The flowchart illustrated in FIG. 7 is initiated based on the user pressing one of the color selection button 413, the file format selection button 414, and the density button 421 on the scan-and-transmit screen 410 in FIG. 4B. Triggers to initiate the flowchart in FIG. 7 are not limited to those described above. For example, the flowchart in FIG. 7 may be initiated in a case where the setting screen illustrated in FIG. 6A, 6B, or 6C is displayed in response to the frontmost screen being closed. Specifically, the flowchart in FIG. 7 may be initiated when the user presses an OK button or a cancel button on the background adjustment screen 450 or the pop-up 440 for confirming the details of the setting changes.

In step S701, the screen display control unit 301 initiates a display setting update for each button on the setting screen. A button on the setting screen is focused, and the processing proceeds to step S702. For example, in a case where the flowchart is initiated based on the press of the color selection button 413, one of the color setting value buttons 601 to 605 in FIG. 6A is focused. In the present embodiment, neither the OK button 606 nor the cancel button 607 is focused in step S701. However, either the OK button 606 or the cancel button 607 may be configured to be focused.

In step S702, the screen display control unit 301 determines whether the focused button is a button that is affected by the “leave marks such as correction fluid marks” setting. In a case where a result of the determination in step S702 made by the screen display control unit 301 indicates “YES” (YES in step S702), the processing proceeds to step S703, whereas in a case where the result of the determination indicates “NO” (NO in step S702), the processing proceeds to step S706. In the present embodiment, whether the focused button is affected by the “leave marks such as correction fluid marks” setting is determined based on Table 1 below. Although the density setting screen 430 is not a screen for changing the setting items related to the “leave marks such as correction fluid marks” setting, the density setting screen 430 includes buttons that are affected. This is intended to restrict screen transitions to the background adjustment screen 450 for background density adjustment, and the background density adjust button 432 and the background density auto button 433 on the density setting screen 430 are configured to be affected by the “leave marks such as correction fluid marks” setting.

TABLE 1

| | | Affected or not affected |
|---|---|---|
| Setting | | by “leave marks such as |
| screen | Button | correction fluid marks” setting |
| Color | Auto (Color/Gray) | Not affected |
| selection | Auto | Affected |
| screen | (Color/Monochrome) | |
| | Full color | Not affected |
| | Gray scale | Not affected |
| | Monochrome binary | Affected |
| File | JPEG | Not affected |
| format | PDF | Not affected |
| screen | TIFF | Affected |
| | XPS | Not affected |
| | TIFF/JPEG (Auto) | Not affected |
| | OOXML | Not affected |
| Density | Auto | Affected |
| setting | Adjust | Affected |
| screen | | |

On the color selection screen 600, the auto (color/monochrome) button 602 and the monochrome binary button 605 are buttons for setting values that are affected. The other setting value buttons are not affected.

In step S703, the screen display control unit 301 acquires information about the current “leave marks such as correction fluid marks” setting from the RAM 213, and the processing proceeds to step S704.

In step S704, the screen display control unit 301 determines whether the “leave marks such as correction fluid marks” setting acquired in step S703 is enabled (ON). In a case where the result of the determination in step S704 made by the screen display control unit 301 indicates “YES” (YES in step S704), the processing proceeds to step S705, whereas in a case where the result of the determination indicates “NO” (in a case where it is determined that the “leave marks such as correction fluid marks” setting is disabled (OFF)) (NO in step S704), the processing proceeds to step S706.

In step S705, the screen display control unit 301 sets the focused button to a hatched pattern display, and the processing proceeds to step S706. For example, in a case where the focused button on the color selection screen 600 is the auto (color/monochrome) button 602 or the monochrome binary button 605, the processing proceeds to step S705, and in step S705, the focused button is displayed with a hatched pattern. In the present embodiment, the hatched pattern display is used to indicate to the user that the button is unavailable. However, this is not a limitation. For example, in a case where a button is unavailable, the button may be undisplayed on the screen (the button may be hidden), or when the button is pressed, a screen that displays a message indicating that the button is unavailable may be displayed without changing the display on the setting screen.

In step S706, in a case where there is a subsequent button that has not yet gone through steps S701 to S706 on the setting screen, the screen display control unit 301 focuses on the subsequent button, and the processing proceeds to step S701, whereas in a case where there is no subsequent button, the processing proceeds to step S707.

In step S707, the screen display control unit 301 acquires the currently-selected setting value from the RAM 213 and sets the button corresponding to the setting value to the selected state. For example, in the case of FIG. 6A, the auto (color/gray) button 601 is set to the selected state, whereas in the case of FIG. 6B, the PDF button 612 is set to the selected state.

In step S708, the screen display control unit 301 displays the setting screen corresponding to one of the color selection button 413, the file format selection button 414, and the density button 421 that has been pressed to initiate the flowchart, and the process in the flowchart is terminated. For example, in a case where the flowchart is initiated based on the press of the color selection button 413, the color selection screen 600 is displayed in step S708.

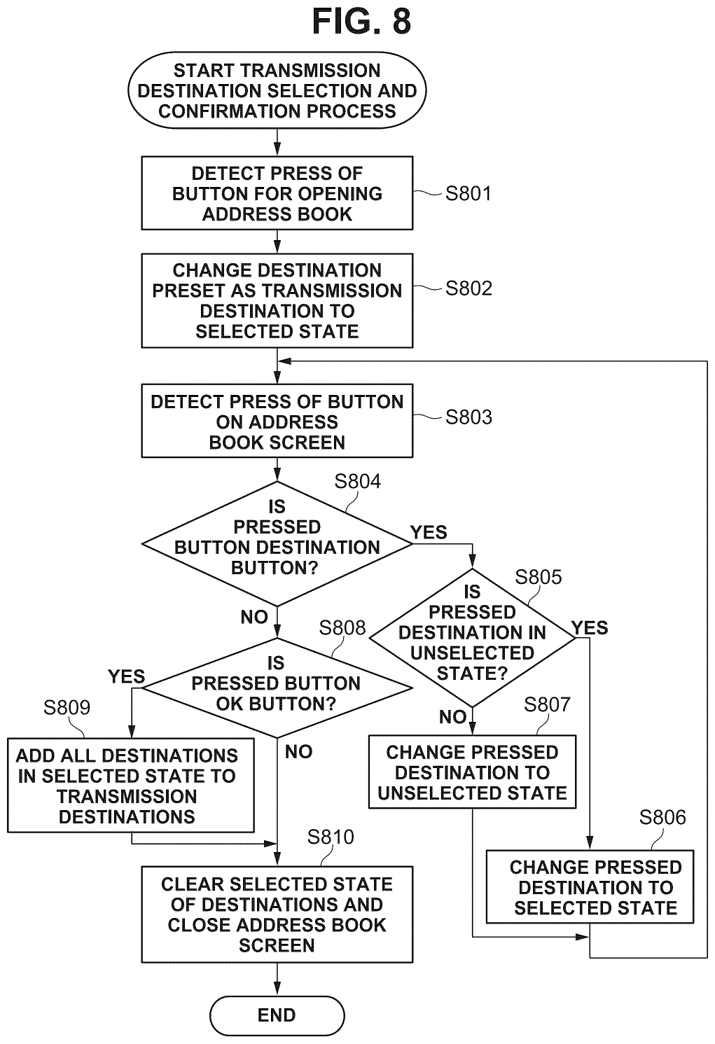

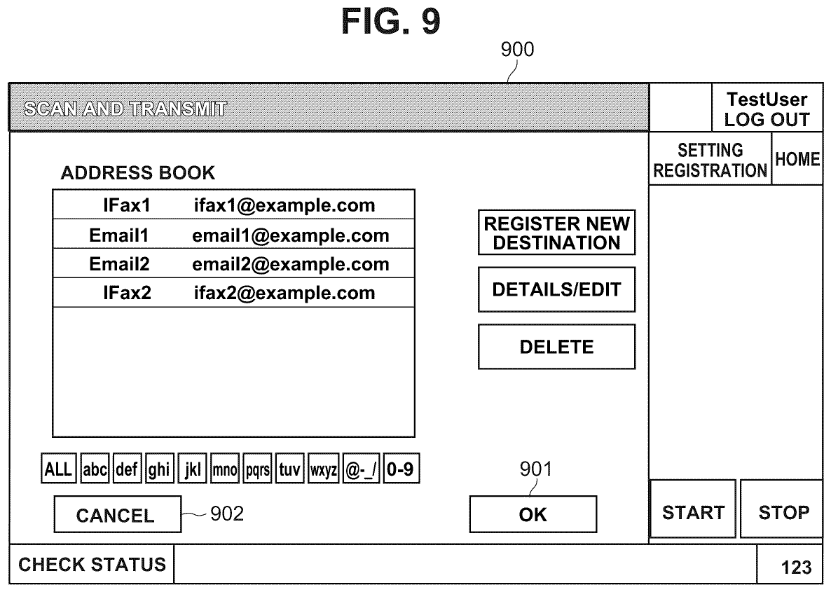

A transmission destination selection and confirmation process in the scan-and-transmit application will be described below with reference to FIGS. 8 and 9.

FIG. 8 illustrates a flowchart for performing the transmission destination selection and confirmation process in the scan-and-transmit application.

In step S801, the operation display unit 220 detects the press of a button for opening an address book. In the present embodiment, transmission destinations are selected from the destinations registered in advance in the address book. However, transmission destinations may be input directly.

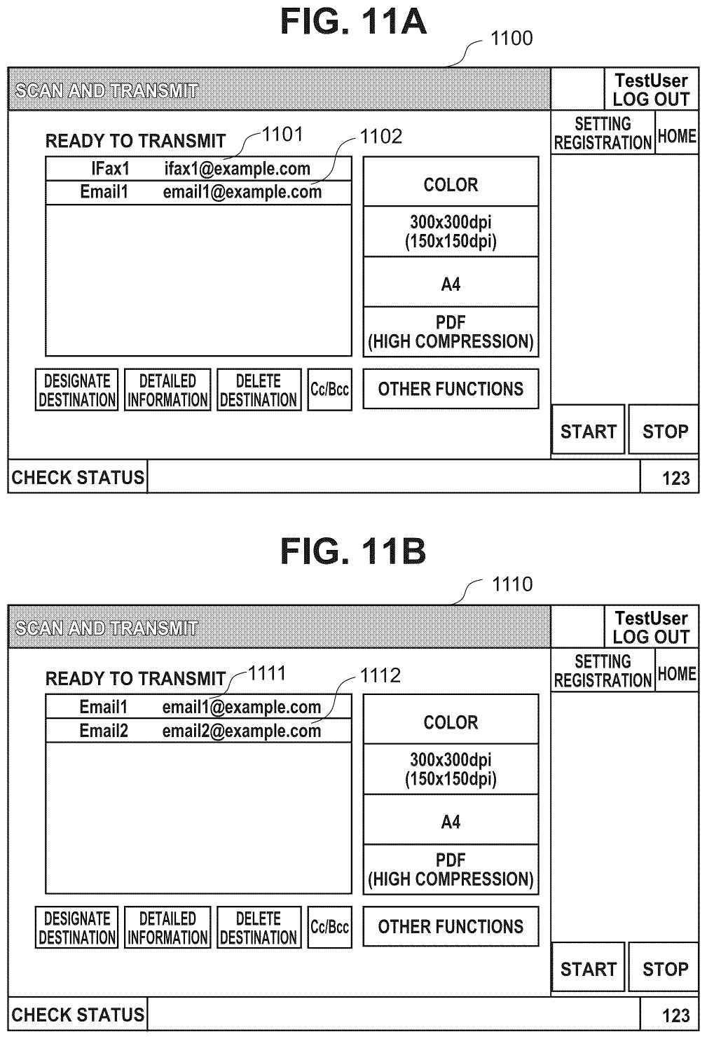

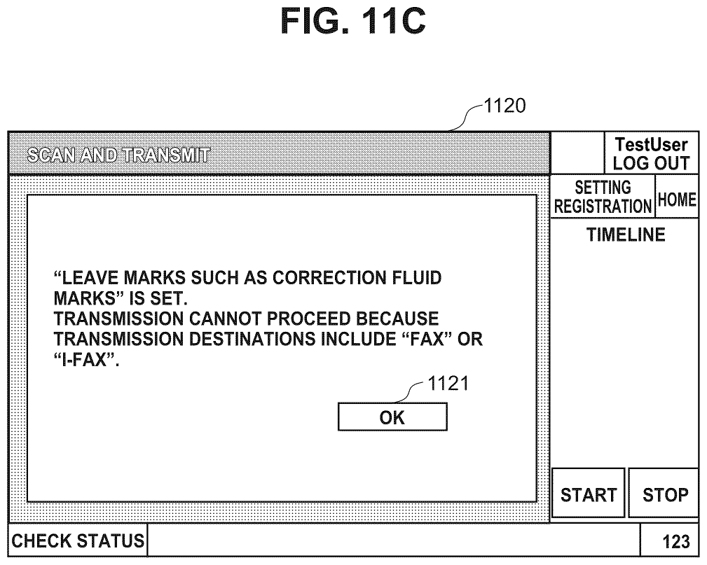

In step S802, the operation display unit 220 displays an address book screen. In a case where the address book screen is displayed by the address book button 411 on the scan-and-transmit screen 410 being pressed, all destinations are displayed in an unselected state. On the other hand, in a case where the address book screen is displayed by a “designate destination” button on a main screen (FIGS. 11A and 11B described below) of the scan-and-transmit application being pressed, the destination preset as the transmission destination before the flowchart is initiated is changed to the selected state. After the operation in step S802 is completed, the processing proceeds to step S803.

FIG. 9 illustrates an example of an address book screen to be displayed when a button for opening the address book is pressed. This address book screen is displayed in a case where an “address book” button in FIG. 4B is pressed. The address book screen is intended to highlight each selected destination to indicate to the user that the highlighted destination is in the selected state. The address book screen illustrated in FIG. 9 is in a state in which no destinations are selected (state in which the address book is opened with no destinations selected).

In step S803, the operation display unit 220 detects the press of a button on the address book screen. Thereafter, the processing proceeds to step S804.

In a case where the operation display unit 220 determines that the pressed button corresponds to a destination in the unselected state (YES in step S804 and YES in step S805), in step S806, the selected destination is changed to the selected state, and the processing proceeds to step S803.

In a case where the operation display unit 220 determines that the pressed button corresponds to a destination that has already been selected (YES in step S804 and NO in step S805), in step S807, the selected destination is changed to the unselected state, and the processing proceeds to step S803. The address book screen is intended to restore the selected destination from the highlighted state to the original state to indicate to the user that the destination is deselected.

In a case where the operation display unit 220 determines that the pressed button is the OK button (in a case where the OK button is determined to have been pressed in step S808), in step S809, all destinations in the selected state are set (added) to transmission destinations. Thereafter, the processing proceeds to step S810.

In a case where the operation display unit 220 determines that the pressed button is the cancel button (in a case where the cancel button is determined to have been pressed in step S808), the processing proceeds to step S810.

In step S810, the operation display unit 220 clears the selected state of all destinations. In other words, all destinations are changed to the unselected state. Then, the address book screen is closed, the main screen (FIGS. 11A and 11B described below) of the scan-and-transmit application is displayed, and the process in the flowchart is terminated.

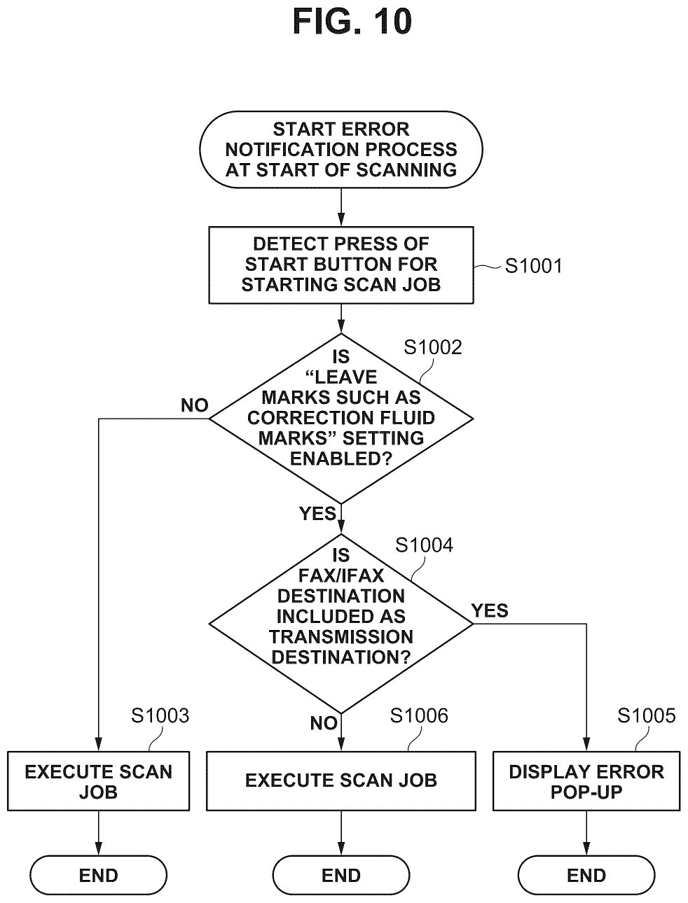

An error notification process at the start of scanning will be described below with reference to FIGS. 10 and 11.

FIG. 10 is a flowchart for an error notification process at the start of scanning.

In step S1001, the job execution button control unit 307 detects the press of a start button for starting a scan job. In a case where the press of the start button is detected, the processing proceeds to step S1002.

FIGS. 11A and 11B illustrate examples of the main screen of the scan-and-transmit application after the transmission destination selection on the address book screen in FIG. 9.

FIG. 11A illustrates an example of a main screen 1100 for cases where FAX/IFAX destinations are included as transmission destinations, and transmission destinations 1101 and 1102 and a start button 1103 are displayed.

The start button for starting a scan job in step S1001 may be the start button 1103 displayed on the main screen 1100 or a start button that is a hardware key (not illustrated). FIG. 11B illustrates an example of a main screen 1110 for cases where no FAX/IFAX destinations are included as transmission destinations, and transmission destinations 1111 and 1112 are displayed.

In a case where the “leave marks such as correction fluid marks” setting is disabled (NO in step S1002), in step S1003, the CPU 211 executes the scan job, and the process in the flowchart is terminated. In a case where the “leave marks such as correction fluid marks” setting is enabled and no FAX/IFAX destinations are included as transmission destinations (YES in step S1002 and NO in step S1004), in step S1006, the

CPU 211 executes the scan job, and the process in the flowchart is terminated. Specifically, in a case where the determination result of step S1002 indicates “YES” and the determination result of step S1004 indicates “NO”, the CPU 211 executes the scan job in step S1006, and the process in the flowchart is terminated.

On the other hand, in a case where one or more FAX/IFAX destinations are included as transmission destinations (YES in step S1002 and YES in step S1004), in step S1005, the screen display control unit 301 displays an error pop-up, and the process in the flowchart is terminated. FIG. 11C illustrates an example of an error pop-up during transmission. In a case where an OK button 1121 is pressed by the user, the screen display control unit 301 closes the error pop-up screen.

FAX/IFAX (fax function) is a function of transmitting binarized documents. In binarized document, marks such as correction fluid marks may not be accurately preserved. Thus, in the present embodiment, job execution is intended to be cancelled in a case where a FAX/IFAX destination is included as a scanned data destination as illustrated in FIG. 11A, even if the “leave marks such as correction fluid marks” setting is enabled.

As described above, in the present embodiment, the MFP 101 can execute the setting for including marks such as correction fluid marks simply by pressing the “leave marks such as correction fluid marks” button 431. The changed setting values can be presented to the user by reflecting the changed setting values in the color selection screen 600 (FIG. 6A), the file format screen 610 (FIG. 6B), and the density setting screen 430 (FIG. 6C). Thus, before executing a job, the user can confirm (grasp) the details of the settings for the job. The changed setting values may be notified collectively using a pop-up screen.

In the embodiment described above, after the “leave marks such as correction fluid marks” button 431 is pressed, the MFP 101 displays the setting screens related to the “leave marks such as correction fluid marks” setting in the state in which the setting values cannot be changed. The MFP 101 thereby prevents the “leave marks such as correction fluid marks” setting, which is intentionally set by the user, from being disabled unintentionally.

In the embodiment described above, in a case where a FAX/IFAX destination is selected as a transmission destination and job transmission is executed after the “leave marks such as correction fluid marks” button 431 is pressed, the MFP 101 displays an error pop-up. The MFP 101 thereby indicates to the user that correction marks cannot be included in document data transmission to the FAX/IFAX destination.

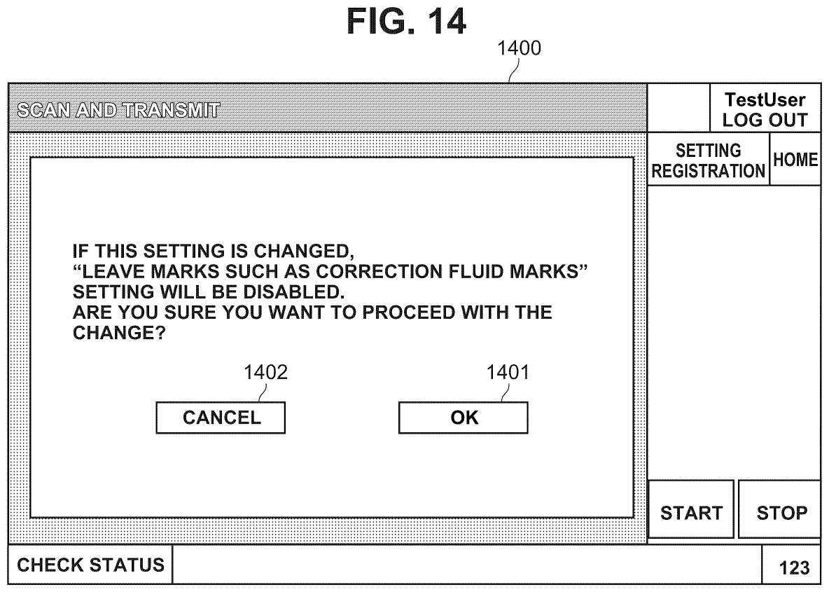

The embodiment describes an example in which pressing the “leave marks such as correction fluid marks” button 431 changes the related setting items to specific setting values. However, this is not a limitation. For example, in a case where a plurality of candidate setting values is selectable for the related setting items, the user may be prompted to select setting values. Specifically, a screen (e.g., FIG. 14 described below) for selecting setting values may be displayed on the operation display unit 220.

A second exemplary embodiment of the present disclosure will be described below. The first embodiment describes a form in which the setting values for the settings related to the “leave marks such as correction fluid marks” setting are displayed with, for example, a hatched pattern in a case where the “leave marks such as correction fluid marks” button is enabled, thereby preventing the setting values from being changed to setting values that disable the “leave marks such as correction fluid marks” setting.

In the present embodiment, a description will be provided of an example of a form in which an error screen is displayed in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

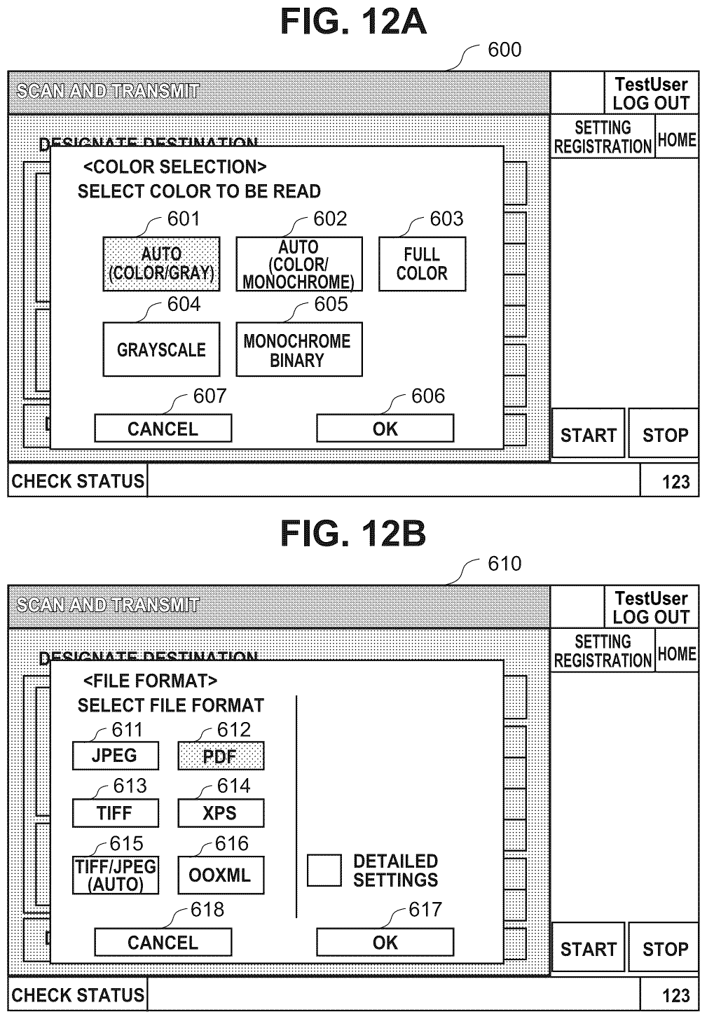

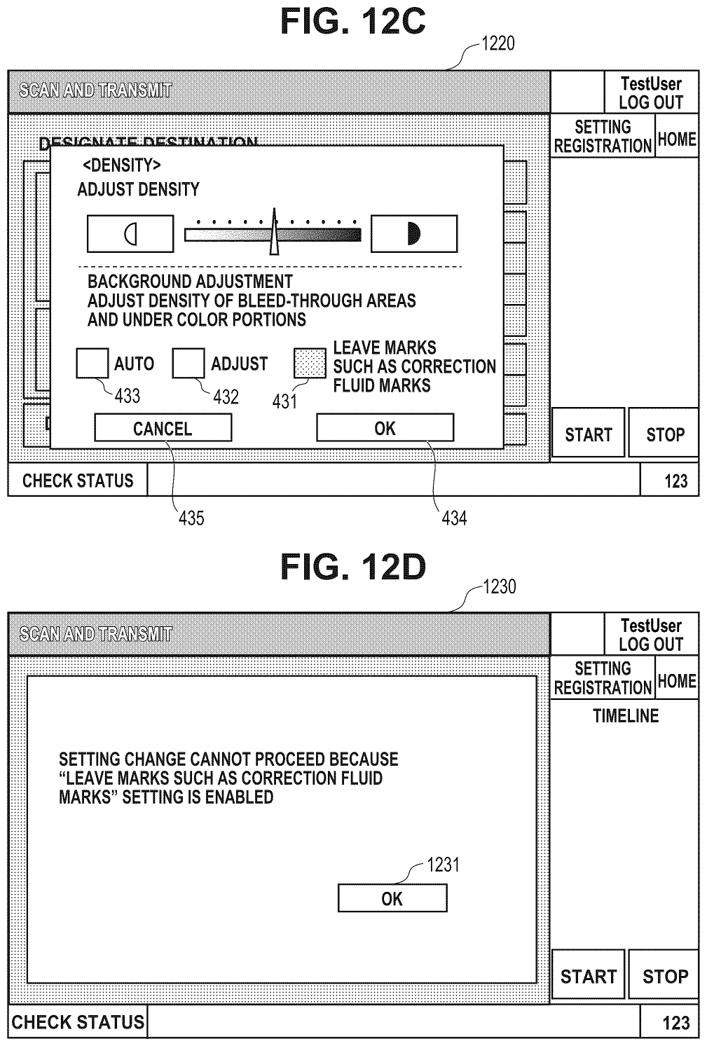

FIGS. 12A to 12D are diagrams illustrating examples of screens displayed on the operation display unit 220 by the screen display control unit 301 in a case where the “leave marks such as correction fluid marks” setting is enabled in the present embodiment.

FIG. 12A is a diagram illustrating an example of a color selection screen 1200 in the present embodiment.

On the color selection screen 1200, buttons similar to those on the color selection screen 600 in FIG. 6A are arranged, and the auto (color/gray) button 601 is in the selected state (highlighted in FIG. 12A).

FIG. 12B is a diagram illustrating an example of a file format screen 1210 in the present embodiment. On the file format screen 1210, buttons similar to those on the file format screen 610 in FIG. 6B are arranged, and the PDF button 612 is in the selected state (highlighted in FIG. 12B).

FIG. 12C is a diagram illustrating an example of a density setting screen 1220 in the present embodiment. On the density setting screen 1220, buttons similar to those on the density setting screen 620 in FIG. 6C are arranged, and the “leave marks such as correction fluid marks” button 431 is in the enabled state (highlighted in FIG. 12C).

FIG. 12D is a diagram illustrating an example of an error pop-up screen 1230 in the present embodiment. The error pop-up screen 1230 is a screen that is displayed in a case where an instruction to change a setting that is unchangeable is issued on the screens illustrated in FIGS. 12A to 12C, and an error message and an OK button 1231 are arranged. Detailed display conditions of the error pop-up screen 1230 will be described in a process described below (step S1303, step S1305).

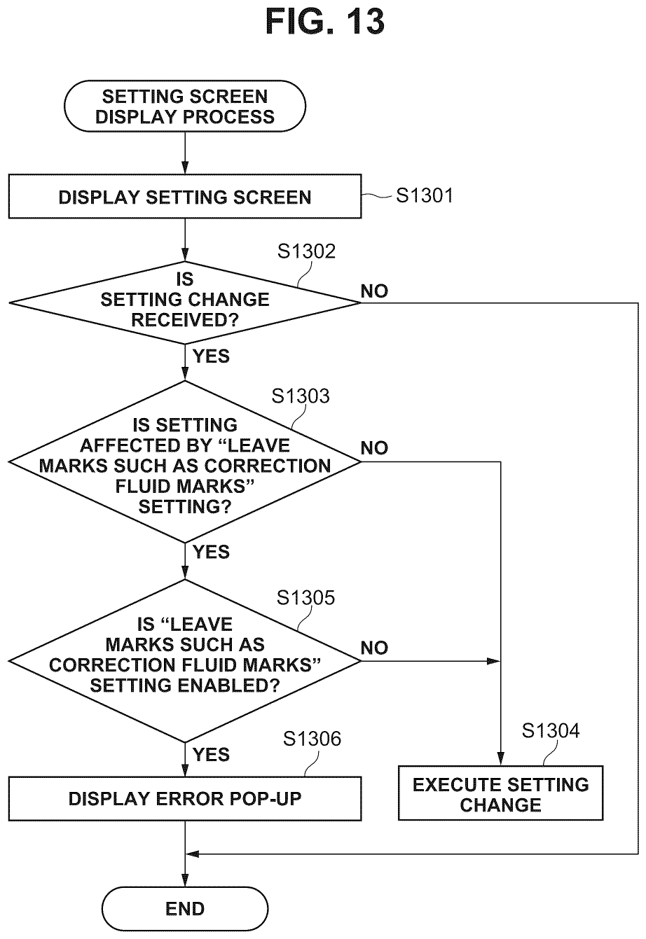

FIG. 13 is a diagram illustrating an example of a flowchart for a setting screen display process for the screens illustrated in FIGS. 12A to 12C in the present embodiment. The CPU 211 of the MFP 101 reads programs for implementing the control modules from the ROM 212 into the RAM 213 and executes the read programs, thereby realizing the flowchart in FIG. 13. Some or all of the functions of the steps illustrated in FIG. 13 may be implemented by hardware, such as an ASIC or electronic circuit.

In step S1301, the screen display control unit 301 displays a setting screen. The displayed setting screen is a screen illustrated in FIGS. 12A to 12C. In a case where one of the color selection button 413, the file format selection button 414, and the density button 421 in FIGS. 4B or 4C is pressed by the user, one of the setting screen corresponds to the pressed button, among the setting screens in FIGS. 12A to 12C, is displayed. Specifically, in a case where the color selection button 413 is pressed, the color selection screen 1200 is displayed. In a case where the file format selection button 414 is pressed, the file format screen 1210 is displayed. In a case where the density button 421 is pressed, the density setting screen 1220 is displayed.

In step S1302, the screen input control unit 302 determines whether a user operation to change a setting is received on the displayed setting screen. For example, in a case where the color selection screen 1200 in FIG. 12A is displayed and the auto (color/monochrome) button 602 or the full color button 603 is pressed and then the OK button 606 is pressed, a setting change instruction is determined to have been received. Alternatively, a setting change instruction may be determined to have been received at the time when the auto (color/monochrome) button 602 or the full color button 603 is pressed. In a case where the cancel button 607 is pressed with none of the setting value buttons being pressed, no setting change instruction is determined to have been received. In a case where the determination result in step S1302 indicates “YES” (YES in step S1302), the processing proceeds to step S1303, whereas in a case where the determination result in step S1302 indicates “NO” (NO in step S1302), the processing in the flowchart is terminated, and the setting screen displayed in step S1301 is closed.

In step S1303, the screen input control unit 302 determines whether the button through which the setting change is received is a button that is affected by the “leave marks such as correction fluid marks” setting. A determination method here is similar to that in step S702 in the first embodiment. In a case where the determination result in step S1303 indicates “YES” (YES in step S1303), the processing proceeds to step S1305, whereas in a case where the determination result in step S1303 indicates “NO” (NO in step S1303), the processing proceeds to step S1304.

In step S1304, the screen display control unit 301 executes the setting change based on the setting change instruction received in step S1302, and the processing in the flowchart is terminated.

In step S1305, the screen input control unit 302 acquires the current “leave marks such as correction fluid marks” setting from the RAM 213 and determines whether the “leave marks such as correction fluid marks” setting is enabled (ON state). In a case where the determination result in step S1305 indicates “YES” (YES in step S1305), the processing proceeds to step S1306, whereas in a case where the determination result of step S1305 indicates “NO” (NO in step S1305), the processing proceeds to step S1304.

In step S1306, the screen display control unit 301 displays an error pop-up screen. For example, the error pop-up screen 1230 illustrated in FIG. 12D is displayed. The error pop-up screen 1230 displays information (message) indicating that in a case where the “leave marks such as correction fluid marks” setting is in the enabled state, changes to settings associated with buttons that are affected by the “leave marks such as correction fluid marks” setting cannot be received. In a case where the OK button 1231 is pressed by the user, the error pop-up screen 1230 is closed with the setting change based on the setting change instruction received in step S1302 not being executed, and the processing in the flowchart is terminated.

As described above, the present embodiment displays an error screen in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

Specifically, in a case where the “leave marks such as correction fluid marks” setting is enabled, the settings associated with the buttons that are affected by the “leave marks such as correction fluid marks” setting are not allowed to be changed on the setting screens. This prevents the “leave marks such as correction fluid marks” setting from being disabled by erroneously changing a setting value although the “leave marks such as correction fluid marks” setting is intended to be enabled. Furthermore, the error screen provides a notification of reasons for inability to change the settings, so that the user understands the reasons for inability to change the setting values, which improves convenience.

A third exemplary embodiment of the present disclosure will be described below. The second embodiment describes a form in which an error screen is displayed in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

The present embodiment describes an example of a form that provides a notification to prompt the user to specify whether to permit a setting change in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

FIG. 14 is a diagram illustrating an example of a warning pop-up screen 1400 to be displayed on the operation display unit 220 by the screen display control unit 301 in a case where the “leave marks such as correction fluid marks” setting is enabled in the present embodiment.

The warning pop-up screen 1400 is displayed in a case where an instruction to change a setting that is unchangeable on the screens illustrated in FIGS. 12A to 12C described above in the second embodiment is issued, and a warning message, an OK button 1401, and a cancel button 1402 are arranged. Detailed display conditions of the warning pop-up screen 1400 are similar to those in the processing described above in the second embodiment (step S1303, step S1305).

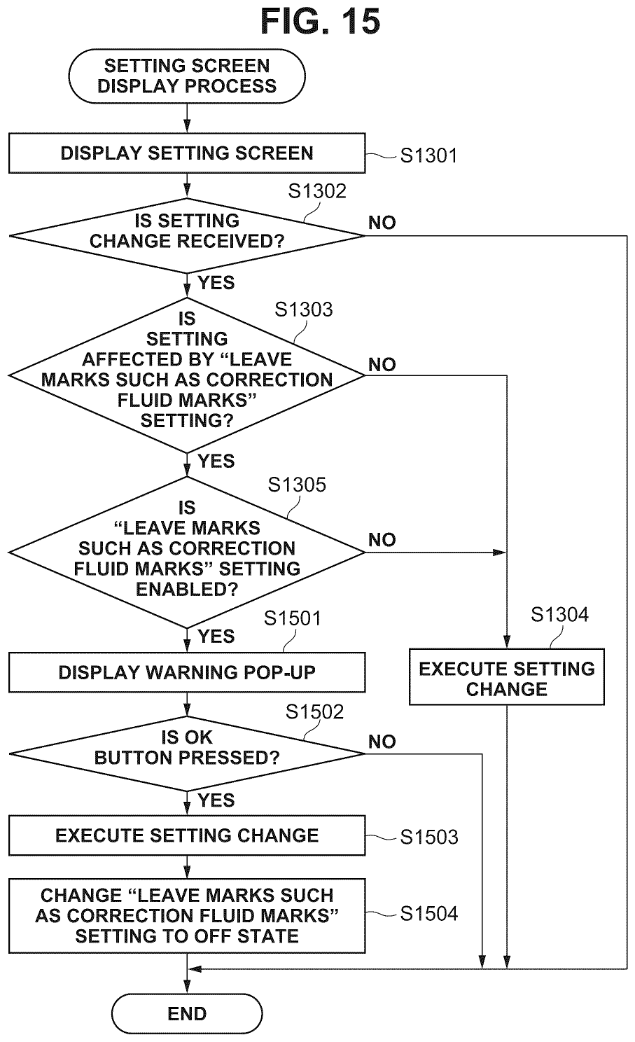

FIG. 15 is a diagram illustrating an example of a flowchart for a setting screen display process on the screens illustrated in FIGS. 12A to 12C in the present embodiment. The CPU 211 of the MFP 101 reads programs for implementing the control modules from the ROM 212 into the RAM 213 and executes the read programs, thereby realizing the flowchart in FIG. 15. Some or all of the functions of the steps illustrated in FIG. 15 may be implemented by hardware, such as an ASIC or electronic circuit.

The operations in steps S1301 to S1305 are similar to those in steps S1301 to S1305 in FIG. 13 described above in the second embodiment, so that descriptions thereof are omitted.

In step S1501, the screen display control unit 301 displays a warning pop-up screen. For example, the warning pop-up screen 1400 illustrated in FIG. 14 is displayed. The warning pop-up screen 1400 displays information (message) indicating that the “leave marks such as correction fluid marks” setting is disabled if a setting associated with a button that is affected by the “leave marks such as correction fluid marks” setting is changed with the “leave marks such as correction fluid marks” setting enabled.

In step S1502, the screen input control unit 302 determines whether the OK button 1401 is pressed on the warning pop-up screen 1400. In a case where the determination result of step S1502 indicates “YES” (YES in step S1502), the processing proceeds to step S1503. In a case where the determination result of step S1502 indicates “NO” (NO in step S1502) (in a case where the cancel button 1402 is determined to have been pressed), the warning pop-up screen 1400 is closed without executing the setting change based on the setting change instruction received in step S1302, and the processing in the flowchart is terminated.

In step S1503, the screen display control unit 301 closes the warning pop-up screen 1400 and executes the setting value change based on the setting change instruction received in step S1302. Either the setting change process or the process of closing the warning pop-up screen 1400 may be executed first.

In step S1504, the screen display control unit 301 changes the “leave marks such as correction fluid marks” setting to the disabled state (OFF state), and the processing in the flowchart is terminated.

The flowchart in FIG. 15 described above illustrates an example in which the warning pop-up screen 1400 is displayed (step S1502, step S1502). However, the setting change process (step S1503, step S1504) may be performed without displaying the warning pop-up screen 1400.

In the present embodiment, a description has been provided of an example of a form that provides a notification to prompt the user to specify whether to permit a setting change in a case where the “leave marks such as correction fluid marks” button is enabled and an instruction to change a setting value for the settings related to the “leave marks such as correction fluid marks” setting to a setting value that disables the “leave marks such as correction fluid marks” setting is issued. This enables the user to select whether to change the setting value after being informed that the change will disable the “leave marks such as correction fluid marks” setting. Even in a case where the “leave marks such as correction fluid marks” button is enabled, the setting values for the settings related to the “leave marks such as correction fluid marks” setting can be changed.

A fourth exemplary embodiment of the present disclosure will be described below. In the third embodiment, a description has been provided of a form that provides a notification to prompt the user to specify whether to permit a setting change in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

The present embodiment describes an example of a form that changes the notification method based on the strength of the correlation with the “leave marks such as correction fluid marks” setting in a case where the “leave marks such as correction fluid marks” button is enabled and an instruction to change a setting value for the settings related to the “leave marks such as correction fluid marks” setting to a setting value that disables the “leave marks such as correction fluid marks” setting is issued.

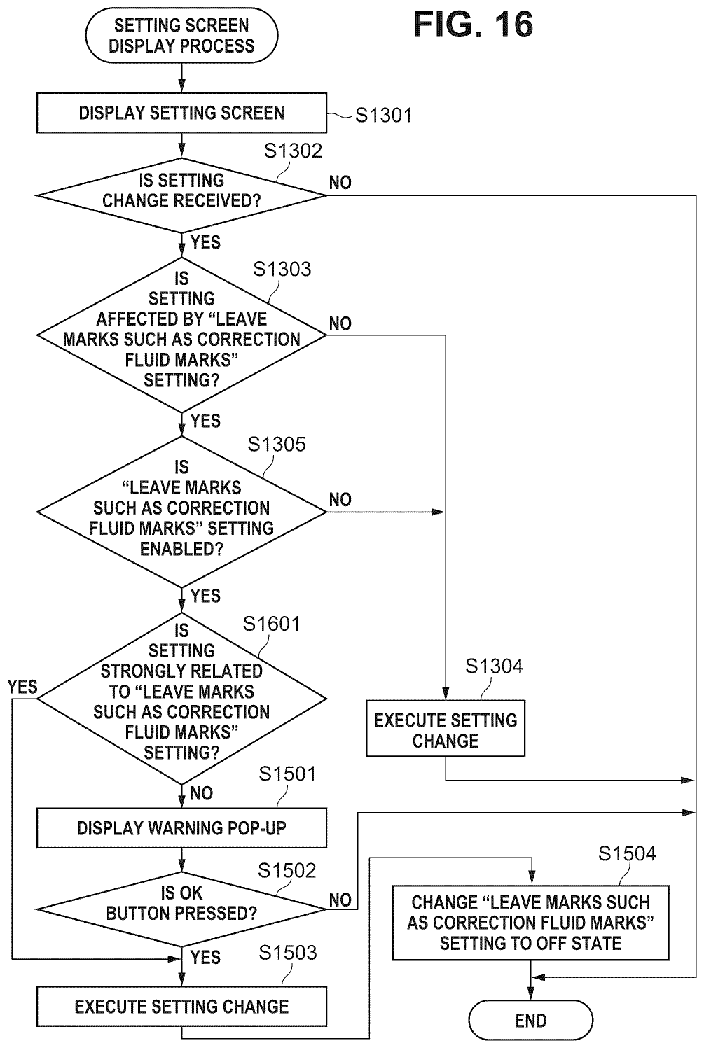

FIG. 16 is a diagram illustrating an example of a flowchart for a setting screen display process on the screens illustrated in FIGS. 12A to 12C in the present embodiment. The CPU 211 of the MFP 101 reads programs for implementing the control modules from the ROM 212 into the RAM 213 and executes the read programs, thereby realizing the flowchart in FIG. 16. Some or all of the functions of the steps illustrated in FIG. 16 may be implemented by hardware, such as an ASIC or electronic circuit.

The operations in steps S1301 to S1305 and steps S1501 to S1503 are similar to those in steps S1301 to S1305 and steps S1501 to S1503 in FIG. 15 described above in the third embodiment, so that descriptions thereof are omitted.

In step S1601, the screen display control unit 301 determines whether the setting for which the setting change has been received in step S1302 has a strong correlation with the “leave marks such as correction fluid marks” setting. In a case where a determination result in step S1601 indicates “YES” (YES in step S1601), the processing proceeds to step S1503, whereas in a case where the determination result in step S1601 indicates “NO” (NO in step S1601), the processing proceeds to step S1501. In the present embodiment, whether the correlation with the “leave marks such as correction fluid marks” setting is strong is determined based on Table 2 below. Auto/adjust of the density setting screen, which is defined as having a strong correlation, is the background density auto button 433 and the background density adjust button 432 in FIG. 12C. The setting buttons are on the same setting screen as the “leave marks such as correction fluid marks” setting, so that they are defined as having a strong correlation. The definitions presented in Table 2 are stored in advance in the ROM 212 or the HDD 214. In the present embodiment, each setting button that is on the same screen as the “leave marks such as correction fluid marks” button is defined as having a strong correlation. However, this is not a limitation, and any setting button present on a screen close to the “leave marks such as correction fluid marks” button 431 may be defined as having a strong correlation.

TABLE 2

| | | Strongly Correlated or Not Strongly |
|---|---|---|
| Setting | | Correlated to “Leave Marks Such as |
| Screen | Button | Correction Fluid Marks” Setting |
| Color | Auto (Color/Gray) | Not Strongly Correlated |
| Selection | Auto | Not Strongly Correlated |
| Screen | (Color/Monochrome) | |
| | Full Color | Not Strongly Correlated |
| | Gray Scale | Not Strongly Correlated |
| | Monochrome Binary | Not Strongly Correlated |
| File | JPEG | Not Strongly Correlated |
| Format | PDF | Not Strongly Correlated |
| Screen | TIFF | Not Strongly Correlated |
| | XPS | Not Strongly Correlated |
| | TIFF/JPEG (Auto) | Not Strongly Correlated |
| | OOXML | Not Strongly Correlated |
| Density | Auto | Strongly Correlated |
| Setting | Adjust | Strongly Correlated |
| Screen | | |

As described above, in the present embodiment, the notification method is changed based on the strength of the correlation with the “leave marks such as correction fluid marks” setting in a case where the “leave marks such as correction fluid marks” button is enabled and an instruction to change a setting value for the settings related to the “leave marks such as correction fluid marks” setting to a setting value that disables the “leave marks such as correction fluid marks” setting is issued. For example, in a case where a setting change is to be made for a setting that is strongly correlated with the “leave marks such as correction fluid marks” setting, even if the warning pop-up screen 1400 is omitted, the user can visually recognize (confirm) that the “leave marks such as correction fluid marks” setting on the same (close) screen is disabled after the setting change is executed. By omitting the display of the warning pop-up screen 1400 in a case where the setting change is to be made for a setting that is strongly correlated with the “leave marks such as correction fluid marks” setting, user inconvenience is reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014587, filed Feb. 2, 2024, which is hereby incorporated by reference herein in its entirety.

What is claimed is:

1. An image processing apparatus, comprising:
at least one memory that stores a set of instructions; and
at least one processor that executes the instructions causing the image processing apparatus to perform operations comprising:
a generating unit configured to generate document data based on a read document;
a setting unit configured to enable a correction mark setting for including a correction mark in the document data to be generated by the generating unit, the correction mark indicating that a correction has been made in the document; and
a display control unit configured to perform, in a case where the correction mark setting is enabled, display control regarding the enabling of the correction mark setting.

2. The image processing apparatus according to claim 1, wherein, in a case where the correction mark setting is enabled and a setting screen for a setting related to the correction mark setting is displayed, the display control unit displays a setting value for the setting related to the correction mark setting as unselectable.

3. The image processing apparatus according to claim 2, wherein, in a case where the correction mark setting is enabled and the setting screen for the setting related to the correction mark setting is displayed, the display control unit displays the setting value for the setting related to the correction mark setting as grayed out.

4. The image processing apparatus according to claim 2, wherein, in a case where the correction mark setting is enabled and the setting screen for the setting related to the correction mark setting is displayed, the display control unit hides the setting value for the setting related to the correction mark setting.

5. The image processing apparatus according to claim 1, wherein, in a case where the correction mark setting is enabled and an instruction to change a setting value for a setting related to the correction mark setting is received, the display control unit displays a predetermined notification indicating that the setting value for the setting related to the correction mark setting is unchangeable.

6. The image processing apparatus according to claim 1, wherein, in a case where the correction mark setting is enabled and an instruction to change a setting value for a setting related to the correction mark setting is received, the display control unit displays a specific notification that prompts selection as to whether to change the setting value for the setting related to the correction mark setting.

7. The image processing apparatus according to claim 6, wherein the display control unit performs control so that in a case where an operation indicating changing the setting value for the setting related to the correction mark setting is performed on the specific notification, the setting value for the setting related to the correction mark setting is changed, whereas in a case where an operation indicating unchanging the setting value for the setting related to the correction mark setting is performed on the specific notification, the setting value for the setting related to the correction mark setting is not changed.

8. The image processing apparatus according to claim 6, wherein, in a case where the correction mark setting is enabled and the instruction to change the setting value for the setting related to the correction mark setting is received, the display control unit changes the setting value for the setting related to the correction mark setting without displaying the specific notification in a case where the setting value for the setting related to the correction mark setting for which the change instruction is received is strongly correlated with the correction mark setting, or the display control unit displays the specific notification in a case where the setting value for the setting related to the correction mark setting for which the change instruction is received is not strongly correlated to the correction mark setting.

9. The image processing apparatus according to claim 1, wherein an operation to enable the correction mark setting is an operation to select a button configured to enable the correction mark setting, and the button configured to enable the correction mark setting is displayed on a screen related to a density setting.

10. The image processing apparatus according to claim 1, wherein a setting related to the correction mark setting is at least one of a color setting, a file format setting, and a density setting.

11. The image processing apparatus according to claim 1, further comprising a control unit configured to execute a function of transmitting the document data generated by the generating unit.

12. The image processing apparatus according to claim 11, wherein, in a case where a destination set in the function of transmitting the document data is a destination with a fax function, the display control unit displays a screen indicating that the function of transmitting the document data is not to be executed.

13. A control method for an image processing apparatus, the control method comprising:
generating document data based on a read document;
perform setting to enable a correction mark setting for including a correction mark in the document data to be generated through the generating, the correction mark indicating that a correction has been made in the document; and
performing, in a case where the correction mark setting is enabled, display control regarding the enabling of the correction mark setting.

14. A non-transitory storage medium storing a program for causing the image processing apparatus according to claim 1 to function.
